(19) United States
(12) Patent Application Publication
(10) Pub. No.: US 2025/0380337 A1
(43) Pub. Date: Dec. 11, 2025

(54) TECHNIQUE FOR LOCATION EXPOSURE IN OPENROAMING-BASED DEPLOYMENTS

(71) Applicant: Cisco Technology, Inc., San Jose, CA (US)

(72) Inventors: Sri Gundavelli, San Jose, CA (US); Anders Askerup, Frisco, TX (US); Mark Grayson, Maidenhead (GB); Timothy P. Stammers, Raleigh, NC (US)

(21) Appl. No.: 18/960,825

(22) Filed: Nov. 26, 2024

Related U.S. Application Data
(60) Provisional application No. 63/657,196, filed on Jun. 7, 2024.

(51) Int. Cl. H04W 76/50; H04L 61/4511; H04W 64/00

(52) U.S. Cl. CPC H04W 76/50; H04L 61/4511; H04W 64/00

(57) ABSTRACT

A method for exposing a location associated with an emergency call may include receiving, at a first network, a request to initiate an emergency session from a user device associated with a second network. The request may trigger the first network to determine location information of the user device. Data associated with the location information of the user device is maintained by the second network in one or more databases. The method may further include querying, by the first network, the DNS for the location information associated with the user device. The one or more databases may be updated by the second network. The method may further include receiving, at the first network and from the DNS via the one or more databases, the location information associated with the user device. The method may further include updating the emergency session based on the location information.

### CROSS REFERENCE TO RELATED APPLICATIONS

This application claims priority to U.S. Patent Application No. 63/657,196, filed June 7, 2024, entitled “TECHNIQUE FOR LOCATION EXPOSURE IN OPENROAMING-BASED DEPLOYMENTS,” which is incorporated by reference herein in its entirety.

### TECHNICAL FIELD

The present disclosure relates to wireless communication systems, and in particular to improving reliability of high security and emergency preparedness communications services (EPCS) in Wireless Access Networks such as Wi-Fi networks.

### BACKGROUND

National Security and Emergency Preparedness (NS/EP) personnel play a critical role in safeguarding communities and ensuring that essential services continue to function during emergency events. These personnel are often first responders, healthcare providers, law enforcement, and other professionals who are vital to the immediate and coordinated response to crises such as natural disasters, public health emergencies, or security threats.

Oftentimes, during such emergency events, communication networks can become strained and congested due to the increased volume of users attempting to access them simultaneously. In recognition of this challenge, Emergency Preparedness Communications Service (EPCS) concept has been introduced in wireless network architectures. The EPCS feature is specifically designed to provide priority access to communication resources for NS/EP personnel, thereby ensuring that their critical communications take precedence over other traffic on the network.

Wi-Fi calling can play an important role in EPCS. One of the significant challenges with Wi-Fi calling lies in accurately determining the caller's location during emergency situations. Currently, users are required to manually configure their address in their devices for Wi-Fi calling purposes. However, this static configuration poses a problem: it lacks accuracy, especially when users are mobile. As users move from one location to another, their configured address may not reflect their actual location accurately. Consequently, when users make emergency calls over Wi-Fi, emergency dispatch systems may receive incorrect or outdated location information, hindering timely and efficient emergency response efforts.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates a schematic diagram of an example of an environment including home and visited wireless communication networks according to some aspects of the present disclosure.

FIG. 2 illustrates a schematic diagram of an example of an environment for exposing a location associated with an emergency call according to some aspects of the present disclosure.

FIGS. 3A–3C illustrate an example process for providing accurate location information during a Wi-Fi call according to some aspects of the present disclosure.

FIG. 4 illustrates a method 400 for exposing a location associated with an emergency call according to some aspects of the present disclosure.

FIG. 5 shows an example of a system for implementing certain aspects of the present technology according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### OVERVIEW

Aspects of the present disclosure are directed to techniques for determining a geographic location of a user device requesting a Wi-Fi emergency call, a first network associated with an Emergency Call Session Control Function (E-CSCF) may discover location information (hereinafter, location information may be used interchangeably with terminologies including location data, location function, Customer Location Function, or any combination thereof) using a Domain Name System (DNS). The user device may request an emergency Wi-Fi call while connected to a second network via an access point associated with the second network. In some examples, the user device may be associated with an emergency Passpoint Profile configured to attach to any available Wi-Fi hotspots and/or networks accessible by the user device (e.g., the second network). The second network may generate and/or obtain location information associated with the user device using a short-lived device-specific tag, a location associated with the access point, or any other method to obtain a geographic location associated with the user device. The second network may transmit the location information to one or more databases accessible to DNS, and thus, the first network. For example, the location information may be exposed into the DNS fabric, allowing dynamic discovery of the location information by the first network via one or more signaling messages (e.g., session initiation protocol messages).

In one aspect, a method for exposing a location associated with an emergency call may include receiving, at a first network, a request to initiate an emergency session from a user device associated with a second network. The request may trigger the first network to determine location information of the user device. Data associated with the location information of the user device may be maintained by the second network in one or more databases shared between the first network, the second network, and a Domain Name System (DNS). The method may further include querying, by the first network, the DNS for the location information associated with the user device. The one or more databases may be updated by the second network. The method may further include receiving, at the first network and from the DNS in the one or more databases, the location information associated with the user device. The method may further include updating the emergency session based on the location information. In another aspect, the method may also include establishing a transmission route for subsequent communications associated with the emergency session between an emergency call session control function (E-CSCF) of the first network and the location function of the second network, wherein the transmission route bypasses the DNS.

In another aspect, the one or more databases may include at least a private database and a public database, wherein the one or more databases are accessible through the DNS.

In another aspect, the second network updates the private database accessible through the DNS with the location information of the user device using at least one of a Naming Authority Pointer (NAPTR) record and a Service (SRV) record.

In another aspect, the second network updates the public database accessible through the DNS with the location information of the user device using at least a Canonical Name Record (CNAME record).

In another aspect, the one or more databases includes a MAC address of an access point associated with the user device, the MAC address being indicative of the location information.

In another aspect, the one or more databases includes a short-lived device-specific location tag that is indicative of the location information of the user device.

In one aspect, a system for exposing a location associated with an emergency call may comprise one or more processors and a memory storing instructions that, when executed by the one or more processors, configure the system to receive, at a first network, a request to initiate an emergency session from a user device associated with a second network. The request may trigger the first network to determine location information of the user device. Data associated with the location information of the user device may be maintained by the second network in one or more databases shared between the first network, the second network, and a Domain Name System (DNS). The system may further query, by the first network, the DNS for the location information associated with the user device. The one or more databases may be updated by the second network. The system may further receive, at the first network and from the DNS in the one or more databases, the location information associated with the user device. The system may further update the emergency session based on the location information.

In one aspect, a non-transitory computer-readable storage medium for exposing a location associated with an emergency call may include instructions that when executed by a computer, cause the computer to receive, at a first network, a request to initiate an emergency session from a user device associated with a second network. The request may trigger the first network to determine location information of the user device. Data associated with the location information of the user device may be maintained by the second network in one or more databases shared between the first network, the second network, and a Domain Name System (DNS). The instructions may further cause the computer to query, by the first network, the DNS for the location information associated with the user device. The one or more databases may be updated by the second network. The instructions may further cause the computer to receive, at the first network and from the DNS in the one or more databases, the location information associated with the user device. The instructions may further cause the computer to update the emergency session based on the location information.

Other technical features may be readily apparent to one skilled in the art from the following figures, descriptions, and claims.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

The disclosed technology addresses the need in the art for accurately determining the caller's location during emergency situations using Wi-Fi calling. Currently, users are required to manually configure their address in their devices for Wi-Fi calling purposes. However, this static configuration poses a problem: it lacks accuracy, especially when users are mobile. As users move from one location to another, their configured address may not reflect their actual location accurately. Consequently, when users make emergency calls over Wi-Fi, emergency dispatch systems may receive incorrect or outdated location information, hindering timely and efficient emergency response efforts.

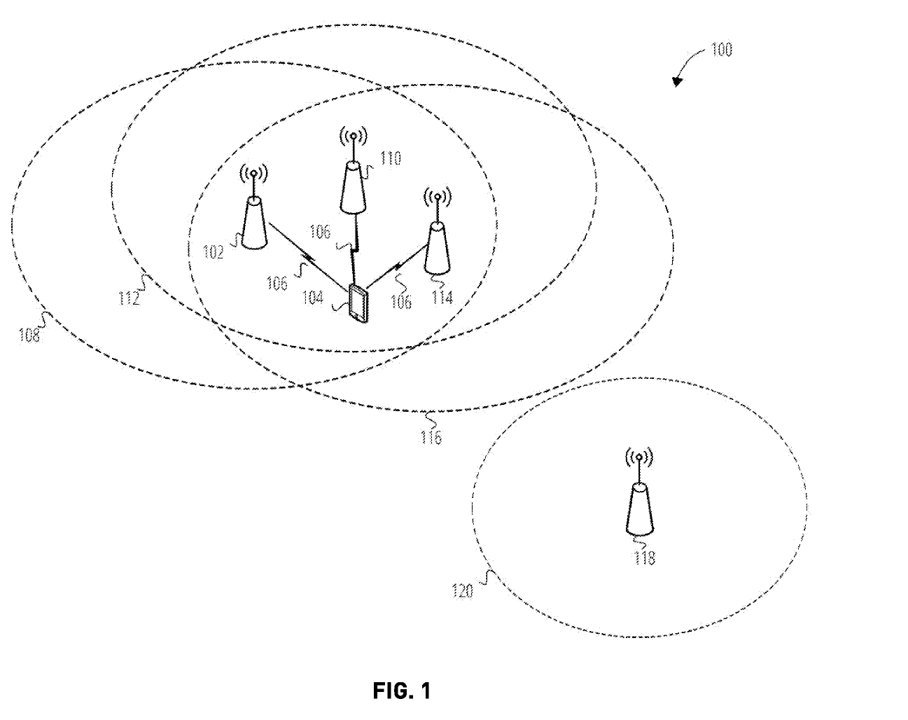

FIG. 1 shows a block diagram of an example a roaming scenario according to some aspects of the present disclosure. The roaming scenario 100 can include a radio access network (RAN) 118 for a home public land mobile network (HPLMN) and RANs for several visited public land mobile network (VPLMN), which are illustrated by RAN 102 for a VLPMN-A, RAN 110 for VLPMN-B, and RAN 114 for VLPMN-C. In FIG. 1, the user equipment (UE) 104 is out of the coverage area 120 of RAN 102 and the HPLMN, but the UE 104 is within the coverage area 108 of the VPLMN-A. Additionally, the UE 104 is within the coverage area 108 of the VPLMN-B, and the UE 104 is within the coverage area 116 of the VPLMN-C. Respective communication links 106 can connect the UE 104 to each of the RANs 102, 110, and 114.In the roaming scenario 100, the UE 104 is a subscriber to the HPLMN, and, when the UE 104 leaves the coverage area 120 of the HPLMN, roaming allows the UE 104 to continue to send and receive messages with by using one of the VPLMNs.

In wireless telecommunications, the term “roaming” can refer to a situation in which mobile devices (e.g., UE 104) are being used outside the range of its native network by connecting to another available cell network. Further, roaming can refer to a functionality in which a cellular customer uses a visited network to automatically make and receive voice calls, send, and receive data, or access other services, including home data services, when travelling outside the geographical coverage area of the home network. For example, should a subscriber travel beyond their cell phone company's transmitter range, their cell phone would automatically hop onto another phone company's service, if available. The term "home network" refers to the network the subscriber is registered with, and "visited network" refers to the network a subscriber roams temporarily and is outside the bounds of the home network. The legal roaming business aspects negotiated between the roaming partners for billing of the services obtained are usually stipulated in roaming agreements3GPP supports steering of roaming (SoR) in which a Home PLMNs uses a roaming partners list (RPL) to steer their roaming subscribers to preferred partner networks by means of updating the Operator Controlled PLMN Selector list via signaling. Using the RPL, an operator can direct a UE 104 to latch on to preferred roaming partner via SoR based on roaming agreement/costs.

In FIG. 1, the UE 104 can latch onto one of the roaming partners VPLMN-A, VPLMN-B, and VPLMN-C. The RPL can be used to ensure that the UE 104 latches onto the visited network with the most favorable roaming agreement/costs. But sometimes the UE 104 can require services/features that are only available from some of the visited networks. The systems and methods described herein overcome this limitation by augmenting the roaming steering process to provide network capability awareness.

Consider an example in which, the UE 104 enables an Access Traffic Steering, Switching and Splitting (ATSSS) feature while roaming, The ATSSS feature allows the diversion of some traffic over Non-3GPP access. Not all visited networks will support ATSSS. Thus, to ensure that the UE 104 latches on to a visited network that supports the desired network capability (i.e., ATSSS in this case), the UE 104 would need to be aware of which visited networks support the desired network capability. For example, it is possible that a given visited network supports both 3GPP/Non-3GPP access but does not support ATSSS, which depends on several enhancements in the core network (e.g., ATSSS-LL, MPTCP, MPTCP Proxy, etc.).

Currently, 3GPP lacks such information as part of RPL in the SoR and there is no way for UE 104 to selectively latch on the visited network where certain specific network capabilities are supported. Although access technology and slice is part of the SoR information which can be used by UE 104 to select a particular visited network based on the supported slice, in the RPL generated by SoR that is provided in 3GPP, the capabilities provided by the visited network are not accounted for, such that a UE 104. If, however, the capabilities provided by the visited network were accounted for (as is the case for certain systems and methods disclosed herein), then the RPL generated by SoR would enable the UE 104 to latch on to the preferred visited network that has the desired network capabilities.

The above example in which the desired network capability is ATSSS is non-limiting, and the desired network capability can be any existing network capability or any network capability that is developed in the future. For example, there are many such capabilities supported by 5GC (ATSSS, non-regulatory Location services or TSN) which may/may not be supported by a visited network. Therefore, bringing network capabilities level cognizance in the RPL is beneficial to enable UEs to select the most appropriate visited network that serves the UEs needs.

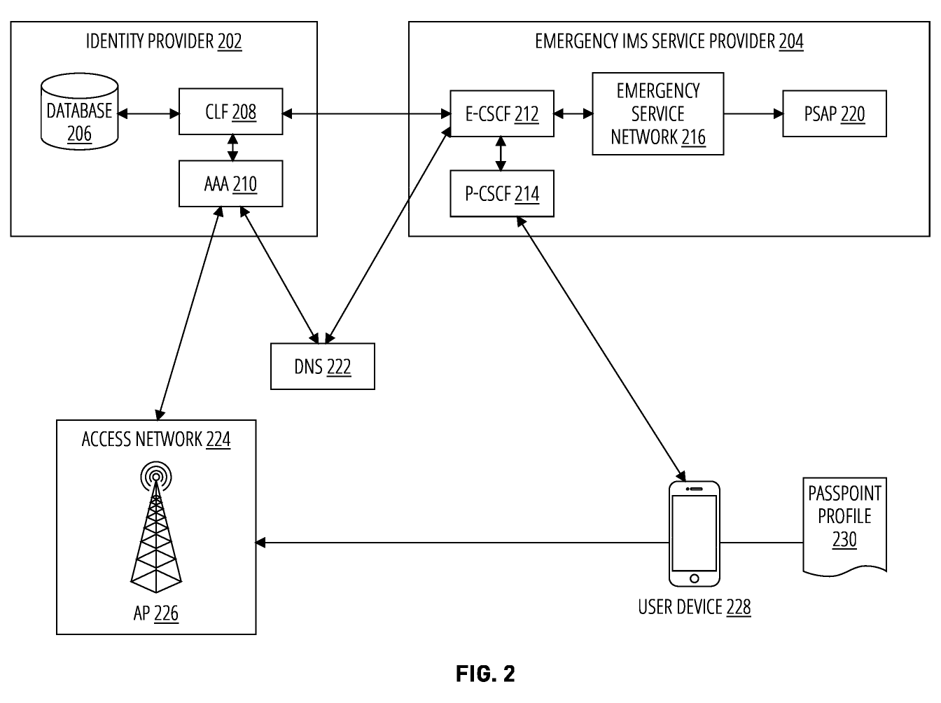

FIG. 2 illustrates a schematic diagram of an example of an environment for exposing a location associated with an emergency call according to some aspects of the present disclosure. In deployments where the access network is part of an OpenRoaming federation made up of access network provider and identity providers, it may be possible to expose the location of the access network and/or the more granular location of a user to an emergency system.

OpenRoaming architecture is a federated framework designed to seamlessly authenticate and connect devices to Wi-Fi networks without requiring user intervention. This framework integrates Wi-Fi networks with identity providers, allowing automatic onboarding by using various known or to be developed protocols and technologies such as Passpoint (Hotspot 2.0) technology, 802.11u protocol, etc. Devices equipped with a pre-configured Passpoint profile can identify and securely connect to participating Wi-Fi networks through Remote Authentication Dial-In User Service (RADIUS)-based authentication, using credentials from trusted identity providers, such as mobile network operators or enterprise services. OpenRoaming leverages federated identity management, where users' credentials are verified by their home provider, enabling secure, scalable, and globally available Wi-Fi access. The architecture also supports end-to-end encryption, ensuring that network communications between the device and the network remain secure, while reducing the friction associated with manually connecting to multiple Wi-Fi hotspots.

Currently, OpenRoaming and similar technologies allow RFC 5580–which defines a set of location-related attributes for the RADIUS protocol–location attributes to be signaled from the access network (AN) to Identity Provider (IDP) and have them be populated in a location function (may also be referred to as Customer Location Function (CLF) or location information). This approach allows the retrieval of the access network’s location, and/or the granular location of the user by performing a location dip into CLF. In scenarios where IP Multimedia Subsystem (IMS) system is part of the same IDP realm, this method is effective. For example, the device latches on to the access network using those IDP credentials and the CLF in that realm is populated. The IMS system knows which CLF to use for retrieving the location. The method works with the assumption that the end device uses default credentials for emergency access, and the IDP realm that authorizes that attach to the Access Network Provider (ANP) is a Federal Communications Commission (FCC) designated IDP, which also hosts emergency calling systems. There is no need for CLF discovery or location exposure mechanisms.

However, OpenRoaming and the similar technologies do not work when a device is already latched on to the access network using some well-known identity credentials (e.g., Example-IDP.com) but wants to emergency Wi-Fi call. The IDP in this case is separate from the FCC designated IMS system. For example, as shown in FIG. 2, identity provider 202 is separate from emergency IMS service provider 204. When this emergency call terminates at the IMS (FCC designated), the Emergency Call Session Control Function (E-CSCF) has no way to discover the CLF function that hosts the device location. In some examples, the access network may force the device to detach and reattach using emergency credentials. This is a risky proposition as it adds delays, especially in an emergency situation. Example embodiments described hereinafter, address this location issue in the OpenRoaming architecture.

Example embodiments described herein may apply in a variety of scenarios such as that shown in FIG. 2 when CLF is part of the IDP realm. In some examples, example embodiments may also apply when the CLF is a public shared Wi-Fi ANP location database. In some other examples, the present technology may be applicable to any access architectures based on OpenRoaming.

In some examples, user device 228 may transmit a request to initiate an emergency Wi-Fi call. The request may be received by access network 224 via access point (AP) 226. User device 228 may be associated with a Passpoint profile 230. Passpoint profile 230 may include configuration data and authentication credentials associated with user device 228 that enable automatic and secure connection to Passpoint-enabled Wi-Fi networks, eliminating the need for manual user intervention. Passpoint profile 230 may include network-specific parameters, such as SSID and roaming consortium identifiers, along with authentication methods, which can include SIM-based credentials, certificates, or username/password combinations, ensuring seamless access to participating networks, such as access network 224, identity provider 202, etc. Passpoint profile 230 may be configured as an emergency Passpoint profile, which may allow user device 228 to attach to any Wi-Fi hotspots/networks that support emergency services for making emergency calls.

Access network 224 may be a wide local area network (WLAN) configured with Passpoint information and Roaming Consortium Organization Identifiers (RCOIs). The request may be received by access network 224 via AP 226 and user device 228 may attached to access network 224. In some examples, when user device 228 attaches to access network 224 via AP 226, access network 224 may be unable to validate the request. Access network 224 may transmit data to the identity provider 202, which may include the location of AP 226 and/or a device-specific location (e.g., provided by a specific location tag (SLT)). Identity provider 202 may be an FCC designated IDP. The data may be transmitted to Authentication, Authorization, and Accounting (AAA) 210 associated with identity provider 202. AAA 210 may authenticate the emergency call request from user device 228, may authorize user device 228 to perform the emergency call, and then may track the usage of user device 228. I

AAA 210 may transmit data received from access network 224 to Customer Location Function (CLF) 208. The CLF (e.g., CLF 208) in IP Multimedia Subsystem (IMS) architecture provides precise location information about a user's device (e.g., user device 228) within the network (e.g., identity provider 202), enabling enhanced location-based services and mobility management. It facilitates the determination of a device’s current connectivity point (e.g., AP 226), which supports functionalities such as emergency call routing and context-aware applications by leveraging detailed network attachment data.

In some examples, identity provider 202 may update a private database with CLF 208 using a Naming Authority Pointer (NAPTR) and/or Service (SRV) record associated with the private database. For example, CLF 208 may update an authoritative name server for the identity provider 202 with service records of CLF 208 using an NAPTR record (e.g., IN NAPTR 10010 "s" "CLF" "" _clf._tcp.example.com) and/or an SRV record (e.g., _clf._tcp.example.com. IN SRV 1008080 clf.example.com). In some other examples, identity provider 202 may update a public database with CLF 208 using a CNAME record. For example, CLF 208 may publish CNAME records (e.g., clf.example.com. IN CNAME PUBLIC-AP-DB.FCC.GOV) points to an external database (e.g., database 206). The private database and/or the public database may be represented by database 206. Identity provider 202 may also update either the public database and/or the private database with the user device 228/AP 226 location. In some examples, identity provider 202 has the authorization keys for updating the private database. In some examples, the user device 228/AP 226 location may be keyed using the MAC address of AP 226 (and/or the MAC address of user device 228), or a short-lived device-specific location tag (SLT) (associated with user device 228 and/or AP 226).

Emergency IMS service provider 204 may receive a SIP request from user device 228 via P-CSCF 214. P-CSCF 214 may direct the emergency call to E-CSCF 212. E-CSCF 212 may query DNS for the location of the user device 228. AAA 210 may provide the CLF 208 to DNS via the private database updated using NAPTR and/or SRV records. In some examples, the location function is exposed into Domain Name System (DNS) fabric, allowing dynamic discovery of the location function using the realm portion in the session initiation protocol (SIP) signaling messages. In some examples, the SIP user agent (UA) is configured to include the IDP realm in the SIP messages. In some examples, E-CSCF 212 may access the location of user device 228 directly using the public database updated by identity provider 202 using the CNAME record. Based on the location, E-CSCF 212 may identify an appropriate PSAP 220 via emergency service network 216. Any additional queries for CLF 208 may be conducted between identity provider 202 and E-CSCF 212 directly, without need to query DNS 222.

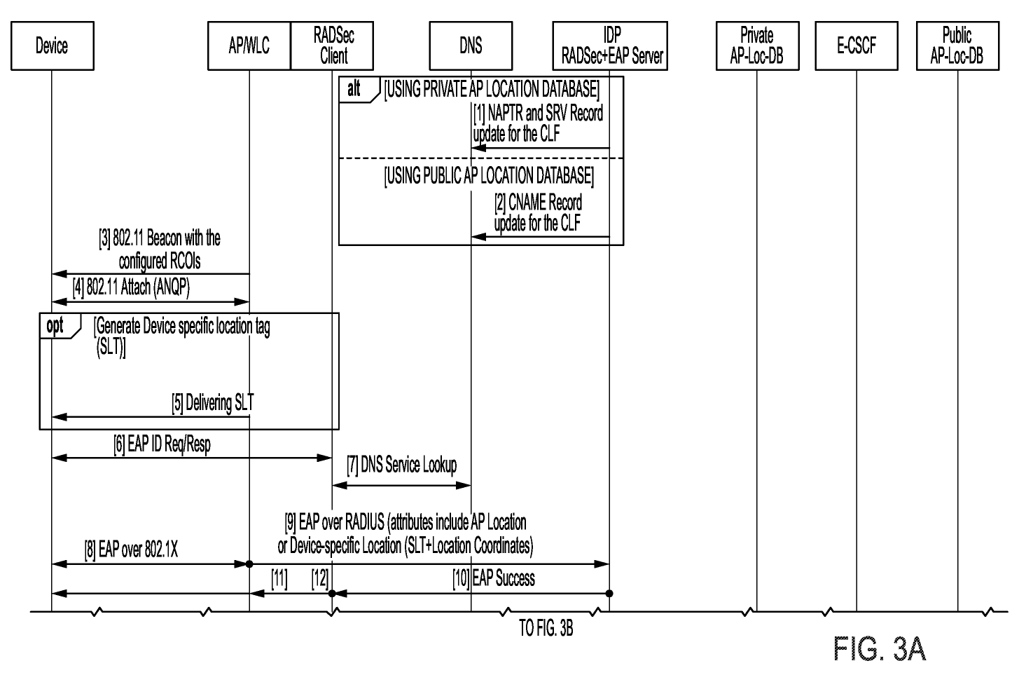

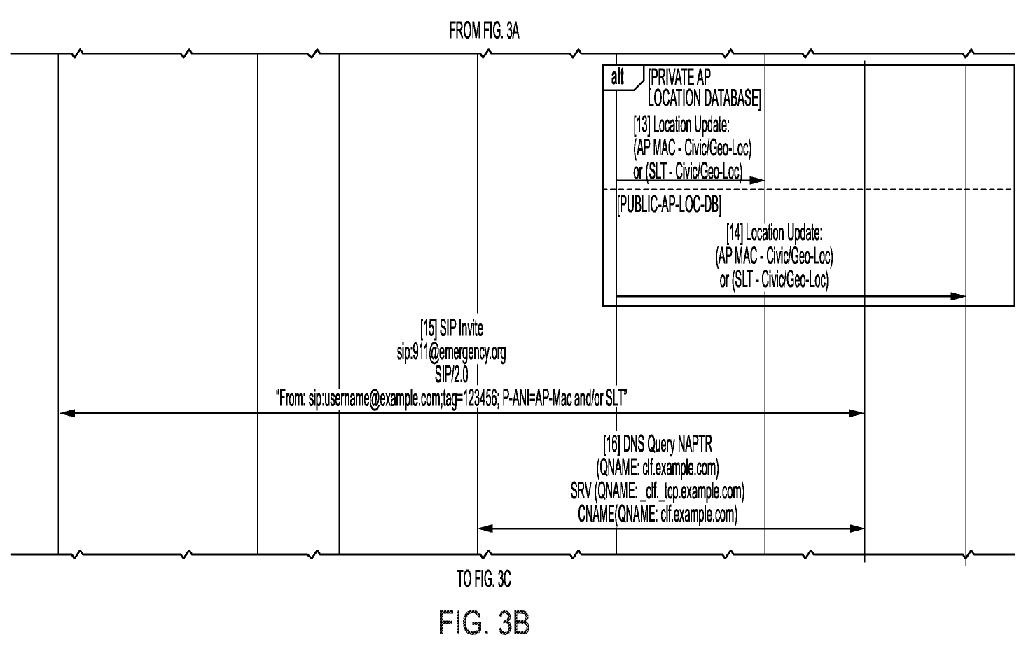

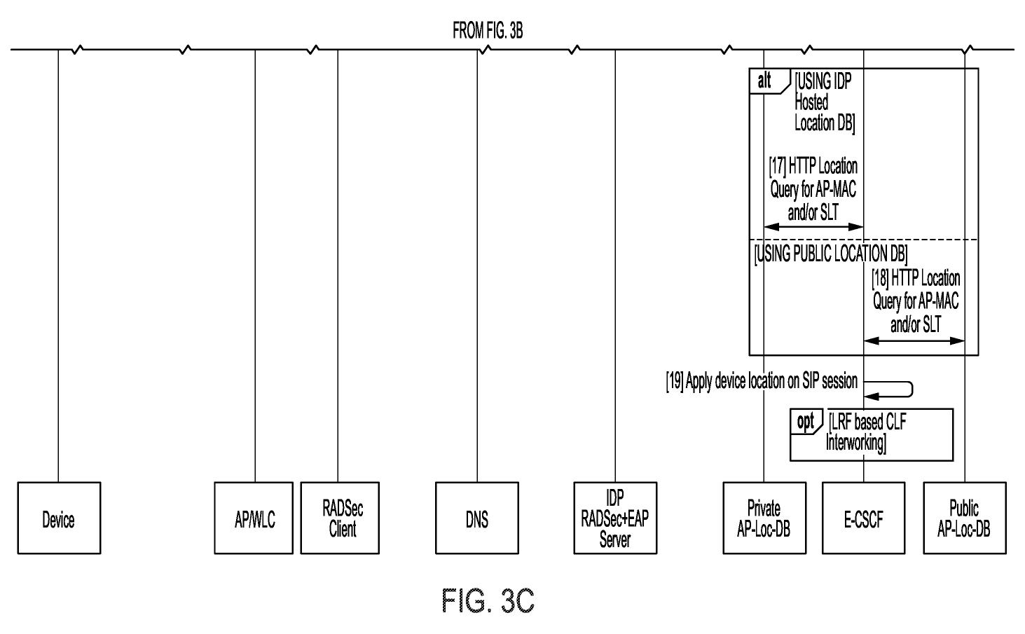

FIG. 3A–3C illustrates an example process for providing accurate location information during a Wi-Fi call according to some aspects of the present disclosure. The process described herein may be an example of a possible implementation of the concepts described herein and is not to be construed as limiting. One or more components may operate alone or in conjunction with each other to perform the operations described herein. For example, a device (e.g., a mobile device, user device, cell phone, smart phone, etc.), an access point and/or wireless local area network controller (AP/WLC), a secure extension of a Remote Authentication Dial-In User Service (RADIUS) Security protocol (RADSec Client), Domain Name System (DNS), identity provider equipped with RadSec and Extensible Authentication Protocol (IDP RADsec + EAP Server), Private AP location database (Private AP-Loc-DB), Emergency Call Session Control Function (E-CSCF), and Public AP location database (Public AP-Loc-DB), may perform the operations described herein to provide accurate location information during an emergency Wi-Fi call. In some examples, the steps described herein may be performed concurrently or may be performed in a sequential order that deviates from the description provided herein.

In some examples, an identity provider (e.g., identity provider 202 described in FIG. 2) may be configured to update one or more databases, including a private access point (AP) location database and/or a public AP location database.

At step 1, the identity provider may be configured to expose updates via the private AP location database to a DNS (e.g., DNS 222) using an NAPTR and/or SRV record associated with a CLF (e.g., CLF 208 described in FIG. 2).

At step 2, the identity provider may be configured to expose updates via the public AP location database to the DNS using a CNAME record associated with the CLF.

At step 3, an AP/WLC (e.g., access network 224 described in FIG. 2) may transmit a beacon broadcast that may include Roaming Consortium Organization Identifiers (RCOIs). The RCOIs may identify the AP/WLC as an authorized network for facilitating emergency Wi-Fi calls.

At step 4, a device may attach to a network associated with the AP/WLC. The device may attach with Access Network Query Protocol (e.g., Passpoint) and an association request for the network. In some examples, the AP/WLC may generate a secure location tag (SLT) associated with a geolocation of the device and/or the AP/WLC itself.

At step 5, the SLT may be delivered to the device.

At step 6, the device may request to be registered using EAP at the RADSec Client.

At step 7, via RADSec Client, a DNS service lookup may be performed to query the DNS for service-related records (e.g., SRV records) to find necessary information to establish a secure connection with a RADIUS server.

At step 8, the device may be authenticated over the RADSec Client connection with the EAP protocol. This may include EAP authentication (e.g., EAP method is initated to determine if the device has valid credentials).

At step 9, the authentication request may be forwarded to a RADIUS server (e.g., IDP RADsec + EAP Server) via a secure RADSec tunnel. The authentication request may include attributes associated with the request, including a geolocation of AP/WLC and/or the SLT (e.g., the device-specific location and coordinates).

Steps 10, 11, and 12 may include confirmation of a successful joining to IDP RADsec + EAP Server.

With reference to FIG. 3B, at step 13, IDP RADsec + EAP Server may update a record at Private AP-Loc-DB using a NAPTR and/or SRV record. The record may include the geolocation and/or the MAC address of AP/WLC. In some examples, the record may include the SLT associated with the device.

At step 14, IDP RADsec + EAP Server may update a record at Public AP-Loc-DB using a CNAME record. The record may include the geolocation and/or the MAC address of AP/WLC. The updated records may be made accessible via DNS exposure. In some examples, the record may include the SLT associated with the device.

At step 15, a Session Initiation Protocol (SIP) invite may be exchanged between the device and E-CSCF. This may initiate the emergency communication session over the Internet. The SIP invitation may include an identity of the device (E.g., username@example.com), a target address (e.g., 911@emergency.org), and a number of tags indicating characteristics of the device (e.g., the SLT, identifiers associated with AP/WLC, etc.).

At step 16, E-CSCF may query DNS (e.g., a NAPTR request, an SRV request, and/or a CNAME request) for a location associated with the device.

With reference to FIG. 3C, at step 17, the E-CSCF may query the Private AP-Loc-DB for the geolocation associated with AP/WLC and/or the SLT.

At step 18, the E-CSCF may query the Public AP-Loc-DB for the geolocation associated with AP/WLC and/or the SLT.

At step 19, E-CSCF may add the obtained location associated with the device (e.g., the geolocation associated with AP/WLC and/or the SLT) and may apply it to the emergency call session associated with the device.

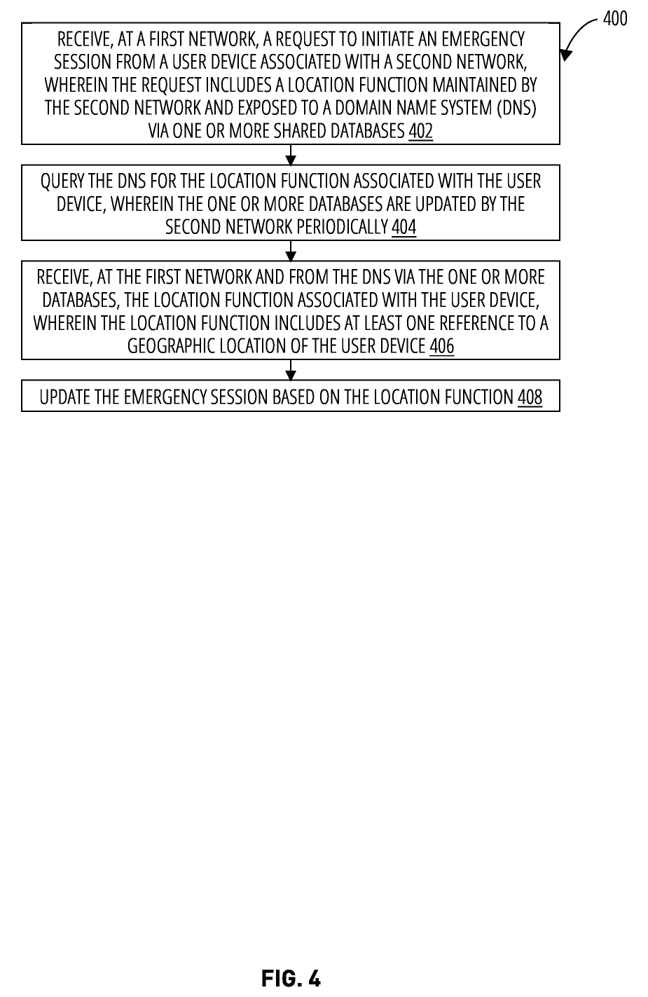

FIG. 4 illustrates a method 400 for exposing a location associated with an emergency call in accordance with one embodiment. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

In block 402 of method 400, a first network receives a request to initiate an emergency session from a user device associated with a second network, wherein the request triggers the first network to determine location information of the user device, and wherein data associated with the location information of the user device maintained by the second network in one or more databases shared between the first network, the second network, and a Domain Name System. For example, emergency service network 216 (described in FIG. 2) may receive a request to initiate an emergency session from user device 228 (described in FIG. 2) associated with identity provider 202 (described in FIG. 2), where the request includes CLF 208 (described in FIG. 2) maintained by identity provider 202 and exposed to DNS 222 (described in FIG. 2) in one or more shared databases (e.g., database 206 described in FIG. 2, Private AP-Loc-DB described in FIGS. 3A–3C, and/or Public AP-Loc-DB described in FIGS. 3A–3C). In some examples, the request may be a SIP invite transmitted by the user device and may be received via EAP protocol and/or RADSec tunnels.

In block 404 of method 400, the first network queries the DNS for the location information associated with the user device, wherein the one or more databases are updated by the second network. For example, emergency service network 216 may query DNS 222 for CLF 208 associated with user device 228, where the one or more databases are updated by IDP RADsec + EAP Server periodically. The query may be a NAPTR query, SRV query, and/or CNAME query. The query may be for a SLT associated with the user device, a geolocation of an associated access point (AP), the MAC address of the associated AP, any combination thereof, or the like.

In block 406 of method 400, the first network receives, from the DNS via the one or more databases, the location information associated with the user device. For example, emergency service network 216 may receive CLF 208 associated with user device 228 from DNS 222, where CLF 208 may include at least one reference to a geographic location of user device 228 (e.g., SLT and/or geolocation of an associated AP). The data may be received in the form of a NAPTR, SRV, and/or CNAME entry from a database.

In block 408 of method 400, the first network updates the emergency session based on the location information. For example, emergency service network 216 may updated the emergency call session based on the CLF 208. In this manner, respective authorities necessary to provide assistance to a user associated with the user device may access an accurate location associated with the user device in order to provide timely and effective assistance.

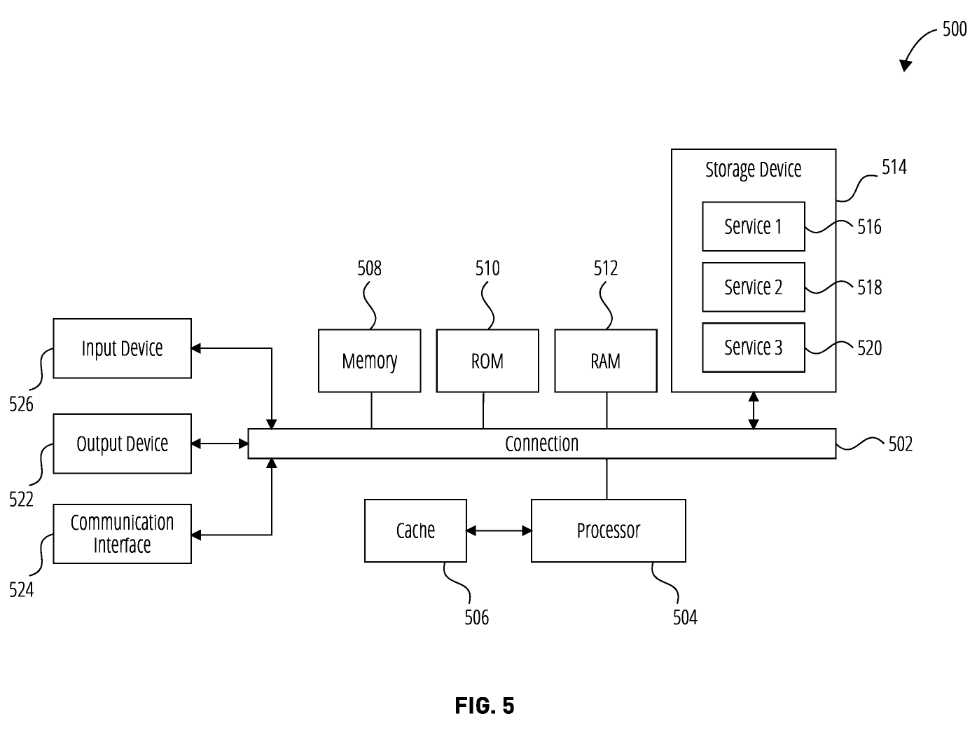

FIG. 5 shows an example of computing system 500, which can be for example any computing device making up FIG. 1, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random-access memory (RAM) 512 to processor 504. Computing system 500 can include a cache of high-speed memory 506 connected directly with, in close proximity to, or integrated as part of processor 504.

Processor 504 can include any general-purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method for exposing a location associated with an emergency call, the method comprising:
receiving, at a first network, a request to initiate an emergency session from a user device associated with a second network, wherein the request triggers the first network to determine location information of the user device, and wherein data associated with the location information of the user device is maintained by the second network in one or more databases shared between the first network, the second network, and a Domain Name System (DNS);
querying, by the first network, the DNS for the location information associated with the user device, wherein the one or more databases are updated by the second network;
receiving, at the first network and from the DNS via the one or more databases, the location information associated with the user device; and
updating the emergency session based on the location information.

2. The computer-implemented method of claim 1, further comprising:
establishing a transmission route for subsequent communications associated with the emergency session between an emergency call session control function (E-CSCF) of the first network and the location information of the second network, wherein the transmission route bypasses the DNS.

3. The computer-implemented method of claim 1, wherein the one or more databases include at least a private database and a public database.

4. The computer-implemented method of claim 3, wherein the second network updates the private database with the location information of the user device using at least one of a Naming Authority Pointer (NAPTR) record and a Service (SRV) record.

5. The computer-implemented method of claim 3, wherein the second network updates the public database with the location information of the user device using at least a Canonical Name Record (CNAME record).

6. The computer-implemented method of claim 1, wherein the one or more databases includes a MAC address of an access point associated with the user device, the MAC address being indicative of the location information.

7. The computer-implemented method of claim 1, wherein the one or more databases includes a short-lived device-specific location tag that is indicative of the location information of the user device.

8. A system comprising:
one or more processors; and
a memory storing instructions that, when executed by the one or more processors, configure the system to:
receive, at a first network, a request to initiate an emergency session from a user device associated with a second network, wherein the request triggers the first network to determine location information of the user device, and wherein data associated with the location information of the user device is maintained by the second network in one or more databases shared between the first network, the second network, and a Domain Name System (DNS);
query, by the first network, the DNS for the location information associated with the user device, wherein the one or more databases are updated by the second network;
receive, at the first network and from the DNS via the one or more databases, the location information associated with the user device; and
update the emergency session based on the location information.

9. The system of claim 8, wherein the instructions further configure the system to:
establish a transmission route for subsequent communications associated with the emergency session between an emergency call session control function (E-CSCF) of the first network and the location information of the second network, wherein the transmission route bypasses the DNS.

10. The system of claim 8, wherein the one or more databases include at least a private database and a public database.

11. The system of claim 10, wherein the second network updates the private database with the location information of the user device using at least one of a Naming Authority Pointer (NAPTR) record and a Service (SRV) record.

12. The system of claim 10, wherein the second network updates the public database with the location information of the user device using at least a Canonical Name Record (CNAME record).

13. The system of claim 8, wherein the one or more databases includes a MAC address of an access point associated with the user device, the MAC address being indicative of the location information.

14. The system of claim 8, wherein the one or more databases includes a short-lived device-specific location tag that is indicative of the location information of the user device.

15. A non-transitory computer-readable storage medium, the non-transitory computer-readable storage medium including instructions that when executed by a computer, cause the computer to:
receive, at a first network, a request to initiate an emergency session from a user device associated with a second network, wherein the request triggers the first network to determine location information of the user device, and wherein data associated with the location information of the user device is maintained by the second network in one or more databases shared between the first network, the second network, and a Domain Name System (DNS);
query, by the first network, the DNS for the location information associated with the user device, wherein the one or more databases are updated by the second network;
receive, at the first network and from the DNS via the one or more databases, the location information associated with the user device; and
update the emergency session based on the location information.

16. The non-transitory computer-readable storage medium of claim 15, wherein the instructions further configure the computer to:
establish a transmission route for subsequent communications associated with the emergency session between an emergency call session control function (E-CSCF) of the first network and the location information of the second network, wherein the transmission route bypasses the DNS.

17. The non-transitory computer-readable storage medium of claim 15, wherein the one or more databases include at least a private database and a public database.

18. The non-transitory computer-readable storage medium of claim 17, wherein the second network updates the private database with the location information of the user device using at least one of a Naming Authority Pointer (NAPTR) record and a Service (SRV) record.

19. The non-transitory computer-readable storage medium of claim 17, wherein the second network updates the public database with the location information of the user device using at least a Canonical Name Record (CNAME record).

20. The non-transitory computer-readable storage medium of claim 15, wherein the one or more databases includes a short-lived device-specific location tag that is indicative of the location information of the user device.
